(19) United States
(12) Patent Application Publication
(10) Pub. No.: US 2016/0196137 A1
(43) Pub. Date: Jul. 7, 2016

(54) Smart Validated Code Searching System

(71) Applicant: International Business Machines Corporation, Armonk, NY (US)

(72) Inventors: Corville O. Allen, Morrisville, NC (US); Sai P. Peddi, Dublin, OH (US)

(21) Appl. No.: 14/720,806

(22) Filed: May 24, 2015

Related U.S. Application Data
(63) Continuation of application No. 14/588,948, filed on Jan. 4, 2015.

(51) Int. Cl. G06F 9/44; G06F 11/36; G06F 9/45

(52) U.S. Cl. CPC G06F 8/71; G06F 8/41; G06F 11/3688; G06F 8/36

(57) ABSTRACT

An approach is provided in which a knowledge manager compiles multiple code snippets that correspond to a question written in a natural language format and creates multiple executable code snippets. The knowledge manager tests the executable code snippets in a runtime environment and generates test results for the various executable code snippets. In turn, the knowledge manager generates code snippet rankings that rank the multiple executable code snippets based on the test results.

### BACKGROUND

Software developers often search for available code snippets to embed into larger software programs to reduce overall software development time. A software developer may search for code snippets written in a specific language that perform specific functions, such as using a search engine to search for a Java implementation of a bubble sort algorithm. The search engine, in turn, returns results that are typically ordered based upon some type of word relevancy (e.g., Java, bubble sort, algorithms, etc.). However, the search engine's results do not guarantee validated code snippets in terms of compilation and execution. As such, the software developer may select a code snippet that is not fully validated or ready for implementation into the software developer's larger software program.

### BRIEF SUMMARY

According to one embodiment of the present disclosure, an approach is provided in which a knowledge manager compiles multiple code snippets that correspond to a question written in a natural language format and creates multiple executable code snippets. The knowledge manager tests the executable code snippets in a runtime environment and generates test results for the various executable code snippets. In turn, the knowledge manager generates code snippet rankings that rank the multiple executable code snippets based on the test results.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts a schematic diagram of one illustrative embodiment of a knowledge manager system in a computer network;

FIG. 2 illustrates an information handling system, more particularly, a processor and common components, which is a simplified example of a computer system capable of performing the computing operations described herein;

FIG. 3 is an exemplary diagram depicting a knowledge manager that generates validated code snippet rankings in response to receiving a code-related question;

FIG. 4 is an exemplary diagram depicting an expanded question answer pipeline that utilizes a runtime environment to verify compiled code snippets and rank the code snippets accordingly;

FIG. 5 is an exemplary diagram depicting a knowledge manager executing different runtime environments and providing different runtime environment views to a client for further analysis;

FIG. 6 is an exemplary high-level flowchart depicting steps to verify executable code snippets and provide code snippet rankings to a user corresponding to a code-related question; and

FIG. 7 is an exemplary flowchart depicting steps to generate executable code snippets from source code snippets and verify the executable code snippets using runtime environments corresponding to their programming language.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, possible answer-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing possible answer information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

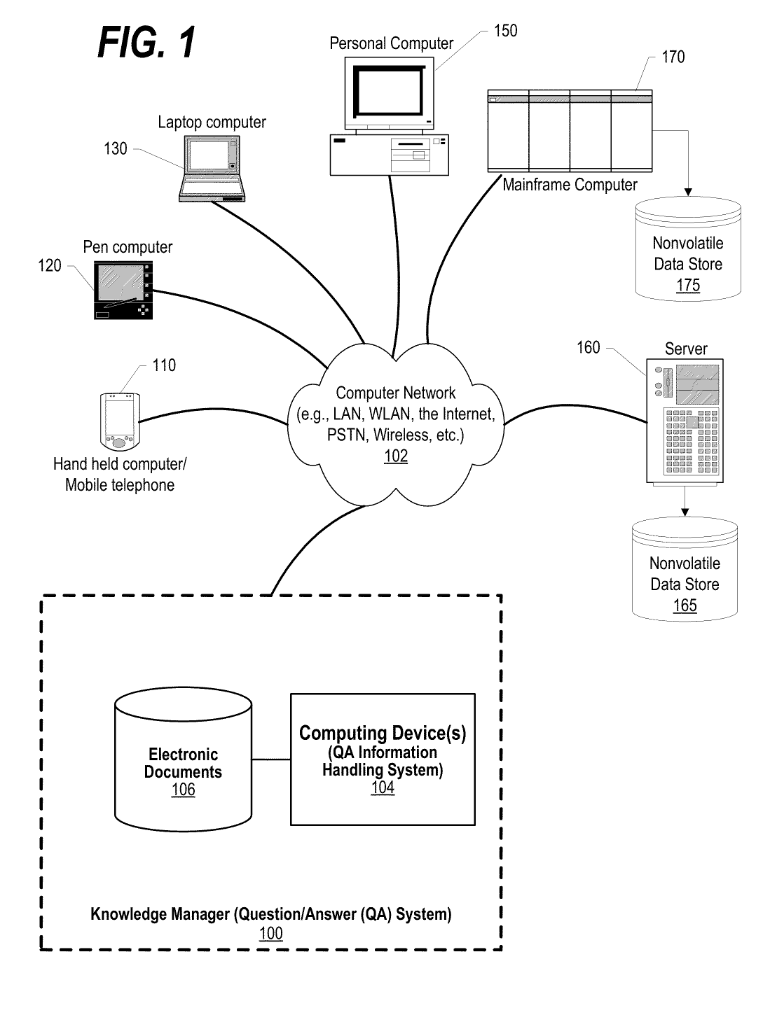

FIG. 1 depicts a schematic diagram of one illustrative embodiment of a question/answer creation (QA) system 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 106 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 100. The document 106 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then performs natural language processing methodologies and parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

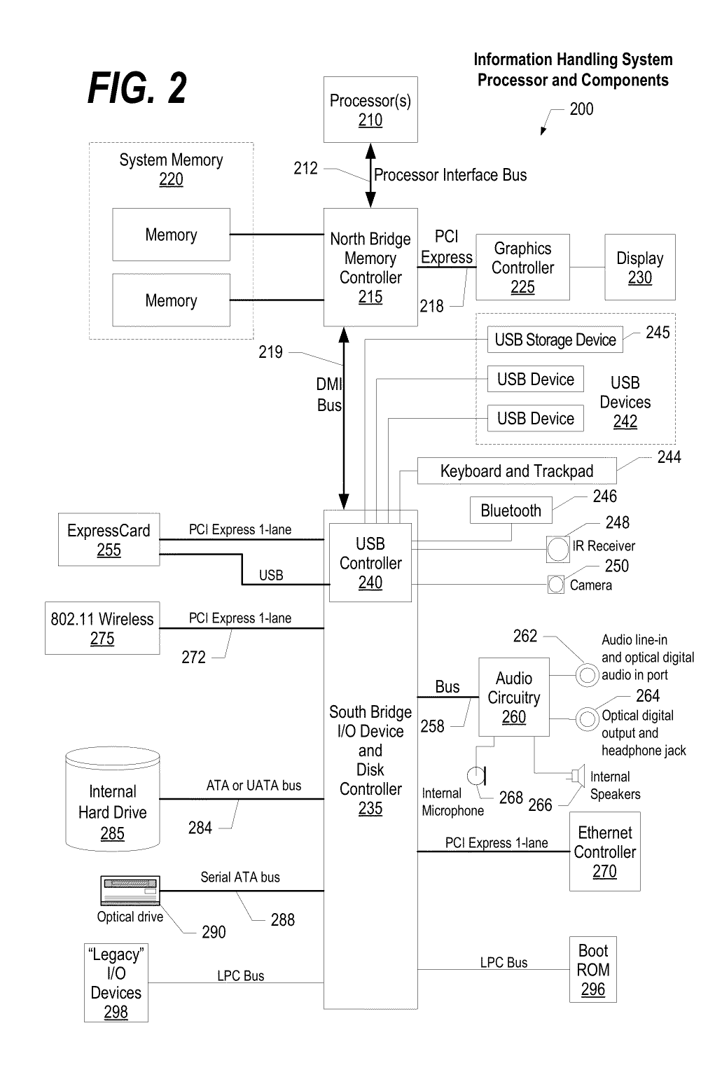

Types of information handling systems that can utilize knowledge manager 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE .802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

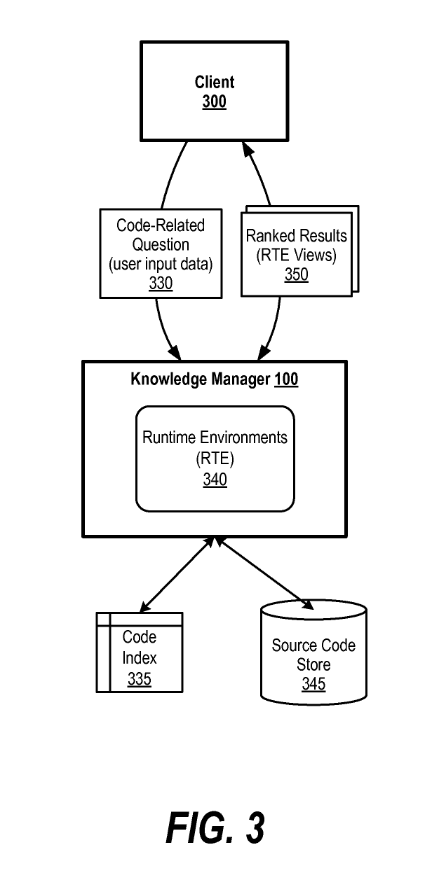

FIGS. 3-8 depict an approach that can be executed on an information handling system. The information handling system receives a code-related question written in a natural language format and uses natural language processing techniques to identify terms and contexts of the question. The information handling system identifies source code snippets based upon the identified terms and contexts, and compiles the source code snippets into executable code snippets accordingly. As such, the information handling system runs the executable code snippets in a runtime environment to test and validate the executable code snippets. The information handling system ranks the executable code snippets and provides the validated and ranked results to a user. In one embodiment, the information handling system inputs user-provided input data into the executable code snippets and refines the ranked results based on comparing the code snippet-generated results with user-provided expected results.

FIG. 3 is an exemplary diagram depicting a knowledge manager that generates validated code snippet rankings in response to receiving a code-related question written in a natural language format. Knowledge manager 100 is a question answering system that parses a natural language question (code-related question 330) using natural language processing techniques and machine learning techniques to identify key terms and contexts of code-related question 330. Knowledge manager 100 searches code index 335 to identify candidate source code snippets corresponding to the identified terms and contexts, and retrieves the candidate source code snippets from source code store 345 accordingly. In one embodiment, code index 335 represents a large amount of source code sources.

Knowledge manager 100 compiles the candidate source code snippets into executable code snippets and invokes runtime environments (runtime environments 340) to run the executable code snippets based on their corresponding programming language. For example, knowledge manager 100 may invoke a virtual machine to execute a Java runtime environment and invoke a different virtual machine to execute a Python runtime environment to run corresponding executable code snippets.

Knowledge manager 100 tests the executable code snippets via runtime environments 340 using parameters such as such as string values, external files on a file system, properties and text. Knowledge manager 100 ranks the executable code snippets based on factors such as execution time, memory allocation amount requirements, code complexity, user preferences, etc. In one embodiment, knowledge manager 100 receives user-provided input data and user-provided expected results to compare against code snippet generated results to refine the rankings of the executable code snippets.

Knowledge manager 100 provides ranked results 350 to the user via client 300. In one embodiment, ranked results 350 include runtime environment views that are linked runtime environments 340, allowing the user to input additional input data and analyze the generated results. In yet another embodiment, ranked results 350 includes licensing terms, etc. for the corresponding code snippets so the user has a complete set of information to select a specific code snippet to use in a larger software program.

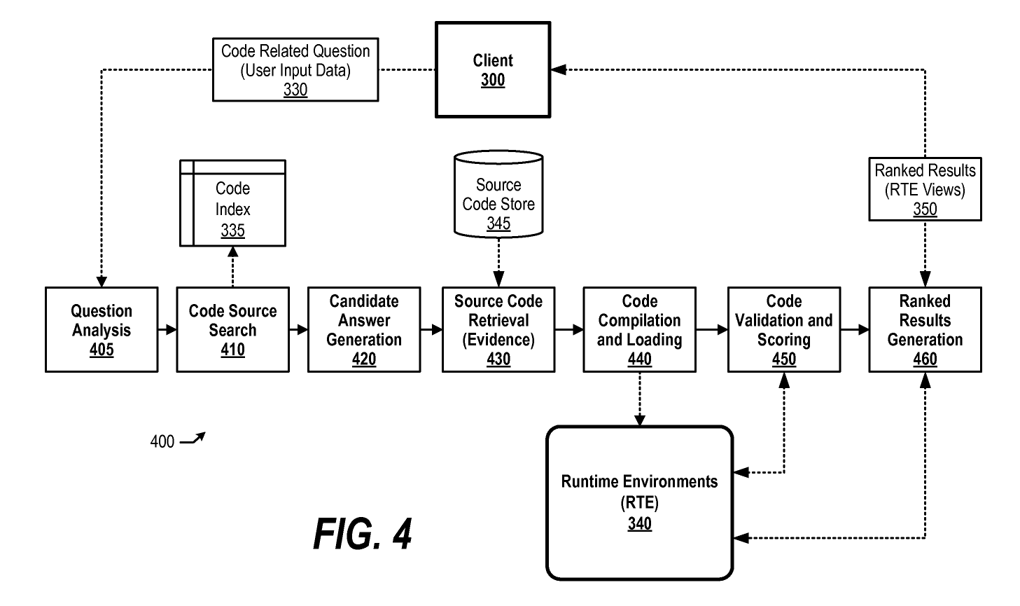

FIG. 4 is an exemplary diagram depicting an expanded question answer pipeline that utilizes a runtime environment to verify compiled code snippets and rank the code snippets accordingly.

A user enters code-related question 330 into client 300 to send to knowledge manager 100. In one embodiment, code-related question 330 may include user-provided input data and user-provided expected results. Pipeline 400 receives code-related question 330 at question analysis stage 405. Code-related question 330 is in a natural language form and, as such, question analysis stage 405 derives terms and contexts (e.g., meanings) within the question. In one embodiment, question analysis stage 405 determines an expected lexical answer type (LAT), which is a word or noun phrase in the question that specifies a type of answer without any attempt to understand its semantics. For example, in the question of “What is a code snippet that adds and subtracts,” the LAT is “code snippet.”

Code source search stage 410 uses the terms and contexts to search code index 335 for perspective code snippets. In one embodiment, code index 335 is a list of code snippets with their corresponding features, programming language, source code links, user reviews, etc. Candidate answer generation stage 420 uses the results from code source search stage 410 to generate candidate answers that knowledge manager 100 subsequently scores and ranks (discussed below).

Source code retrieval stage 430 gathers evidence for the candidate answers, such as by retrieving actual source code snippets from source code store 345, along with information such as user reviews, programming language compatibilities, etc. Code compilation and loading stage 440 compiles the source code snippets into executable code snippets. In one embodiment, knowledge manager 100 uses individual compilers to compile the source code snippets. In another embodiment, knowledge manager 100 loads multiple different programming languages onto multiple virtual machines in runtime environments 340 and compiles the source code snippets using the virtual machine corresponding to the source code snippet's respective programming language.

Code validation and scoring stage 450 uses runtime environments 340 to validate the executable code snippets using various test techniques, such as starting up a client utilizing reflection to execute the code snippet. In one embodiment, code validation and scoring stage 450 generates a client script based on the code snippet that executes in the environment and enables performance metrics when the code snippet commences execution in the runtime environment. For example, code validation and scoring stage 450 may enable Java performance monitoring when a code snippet loads into the runtime environment. In turn, the Java performance monitoring collects and stores metrics in a storage area that code validation and scoring stage 450 subsequently retrieves for analysis and ranking based upon factors such as performance, memory requirements, code complexity, etc.

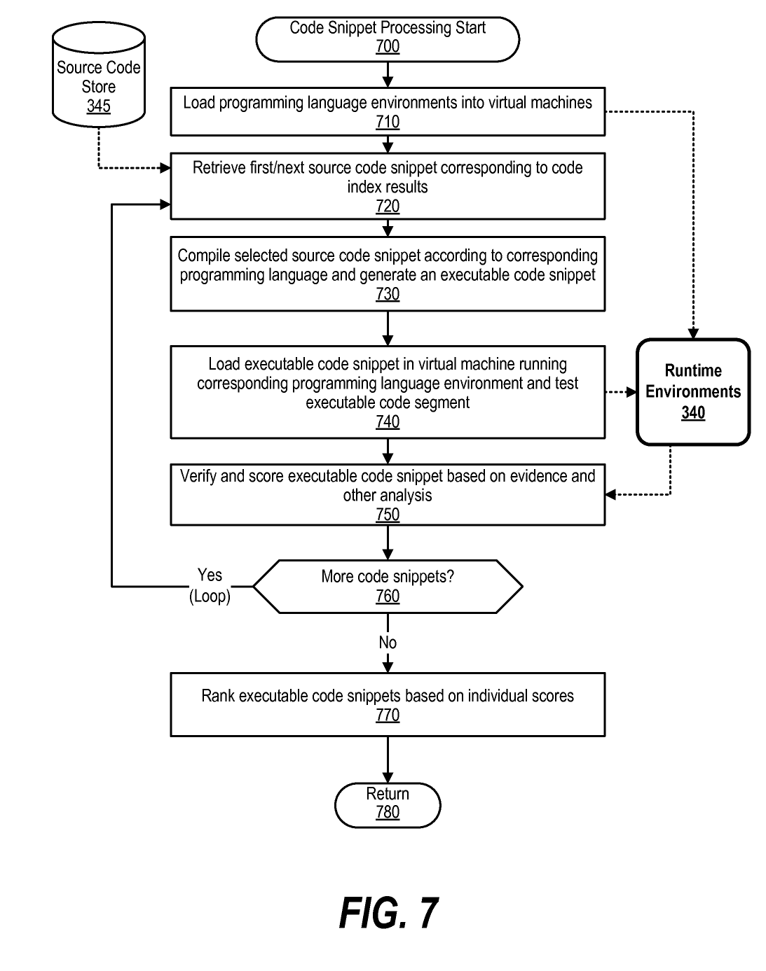

Ranked results generation stage 460 ranks the executable code snippets according to their corresponding scores and provides ranked results 350 to client 300. In one embodiment, ranked results 350 includes runtime environment views linked to runtime environments 340, which provides client 300 with runtime windows. A user may input more data into the runtime windows, which knowledge manager 100 inputs into runtime environment 340 to generate user results that the user evaluates during executable code snippet selection (see FIGS. 7, 8, and corresponding text for further details).

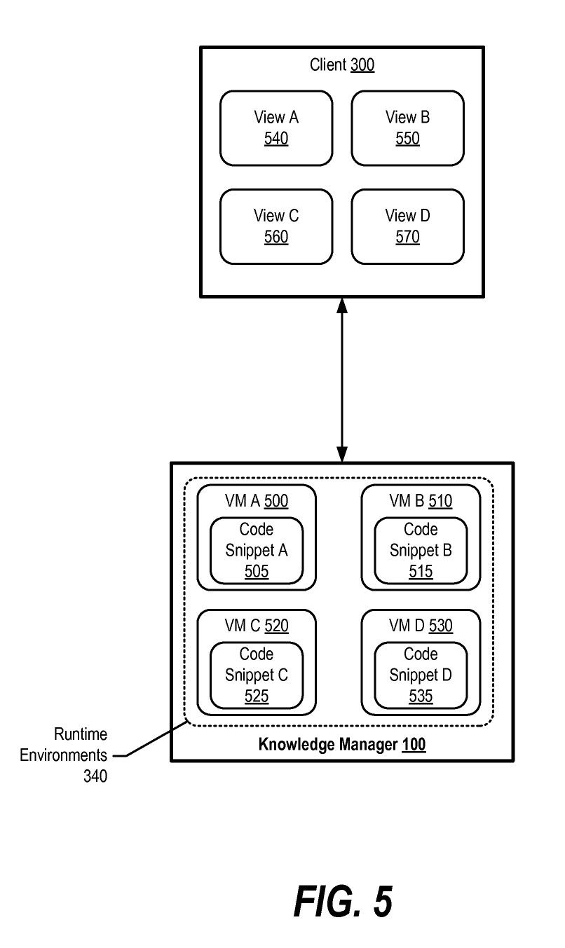

FIG. 5 is an exemplary diagram depicting a knowledge manager executing different runtime environments and providing different runtime environment views to a client for further analysis.

As discussed herein, knowledge manager 100 may invoke multiple virtual machines to run multiple code snippets corresponding to different runtime environment types. FIG. 5 shows that runtime environment 340 includes virtual machines 500, 510, 520, and 530, which are running executable code snippets 505, 515, 525, and 535, respectively.

In addition to evaluating the executable code snippets in terms of speed, size, complexity, etc., knowledge manager 100 also provides runtime views 540, 550, 560, and 570 to client 300. As such, a user may analyze the different executable code snippets before selecting a particular code snippet to utilize in a larger program. For example, the user may want to input a large range of negative and positive numbers and view the results to see if any of the executable code snippets have issues with particular numbers (e.g., negative numbers, small numbers, large numbers, etc.)

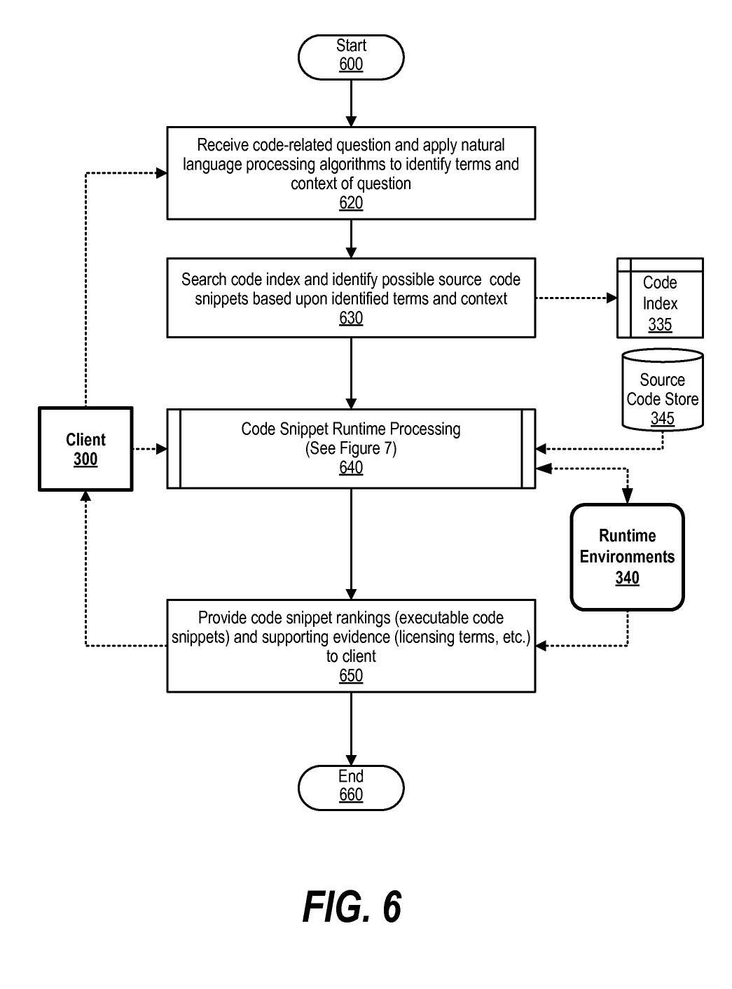

FIG. 6 is an exemplary high-level flowchart depicting steps to verify executable code snippets and provide code snippet rankings to a user corresponding to a code-related question. Processing commences at 600, whereupon, at step 620, the process receives a code-related question initiated by a user through client 300. The process applies natural language processing algorithms to identify terms and context of question. At step 630, the process searches code index 335 to identify possible source code snippets based upon the identified terms and contexts.

Next, at predefined process 640, the process performs code snippet runtime processing on the source code snippets, which includes compiling the source code snippets into executable code snippets and verifying/testing the executable code snippets using compatible runtime environments (see FIG. 7 and corresponding text for processing details). In one embodiment, the process utilizes user-provided input data to test the executable code segments to ensure that the code snippet generated results match user-provided expected results.

At step 650, the process provides the code snippet rankings to the user via client 300. In one embodiment, the code snippet rankings include runtime environment views corresponding to the top-ranked executable code snippets. In this embodiment, the user is able to input more data into the executable code snippets and evaluate the code snippets in action (see FIG. 5 and corresponding text for further details). In another embodiment, the code snippet rankings include supporting evidence to the user that includes licensing terms, evaluation results, code size, speed, stability results, etc., which allow the user to select a specific executable code snippet. FIG. 6 processing thereafter ends at 660.

FIG. 7 is an exemplary flowchart depicting steps to generate executable code snippets from source code snippets and verify the executable code snippets using runtime environments corresponding to their programming language.

Processing commences at 700, whereupon, at step 710, the process loads programming language environments into virtual machines corresponding to the candidate source code snippets identified in FIG. 6's step 630. For example, the process may detect that three source code snippets are based on a Java programming language and four source code snippets are based on a Python programming language. As discussed earlier, runtime environments 340 may include multiple virtual machines such as those shown in FIG. 5.

At step 720, the process retrieves the first source code snippet from source code store 345 that corresponds to the code index results in step 630. At step 730, the process compiles the selected source code snippet, based upon the selected source code snippet's programming language, to generate an executable code snippet. In one embodiment, the process uses individual compilers to compile the source code snippets. In another embodiment, the process loads multiple different programming languages onto multiple virtual machines in runtime environments 340 and compiles the source code snippets using the virtual machine corresponding to the source code snippet's respective programming language.

At step 740, the process loads the executable code snippet into a compatible virtual machine in runtime environment 340 that executes the corresponding programming language. The process tests the loaded code snippet, such as by checking whether the code snippet generates compilation errors, running the program using two input numbers provided by a user and validating different answers produced by the code snippets, etc. In one embodiment, the process may use reasoning algorithms to understand the code complexity (time and space) of the code snippets. At step 750, the process verifies and scores the executable code snippet based on evidence and other analysis such as code snippet execution time, memory requirements (runtime memory allocation amount), code complexity analysis, user reviews, etc.

The process determines as to whether there are more code snippets for which to evaluate (decision 760). If more there are more code snippets to evaluate, then decision 760 branches to the ‘yes’ branch to select, compile, test, and score the next code snippet. This processing continues until there are no more code snippets to evaluate, at which point decision 760 branches to the ‘no’ branch. At step 770, the process ranks the executable code snippets based on the individual scores. FIG. 7 processing thereafter returns to the calling routine (see FIG. 6) at 780.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
compiling at least a first source code snippet based on a first programming language and a second source code snippet based on a second programming language, resulting in at least a first executable code snippet and a second executable code snippet, respectively, wherein the first source code snippet and the second source code snippet correspond to a same one or more functions;
testing the first executable code snippet and the second executable code snippet in one or more runtime environments, resulting in a plurality of test results;
generating one or more code snippet rankings corresponding to the first executable code snippet and the second executable code snippet based upon the plurality of test results;
providing a plurality of runtime views to a user based upon the one or more code snippet rankings;
receiving user-provided input data from the user through at least one of the plurality of runtime views;
inputting the user-provided input data into at least one of the first executable code snippet or the second executable code snippet, resulting in one or more code snippet results; and
providing the one or more code snippet results to the user through at least one of the plurality of runtime views.

2. The method of claim 1 wherein, prior to the compiling of the first source code snippet and the second source code snippet, the method further comprises:
identifying one or more terms and one or more contexts of the one or more terms in response to performing natural language processing on a question; and
searching a code index using the identified one or more terms and the one or more contexts, resulting in selection of the first source code snippet and the second source code snippet.

3. The method of claim 1 further comprising:
inputting user-provided input data to the first executable code snippet and the second executable code snippet during the testing of the first executable code snippet and the second executable code snippet, resulting in a plurality of code snippet results; and
utilizing the plurality of code snippet results during the generation of the one or more code snippet rankings.

4. The method of claim 3 further comprising:
comparing the plurality of code snippet results against user-provided expected results, resulting in an adjustment of at least one of the one or more code snippet rankings.

5. (canceled)

6. (canceled)

7. The method of claim 1 further comprising:
loading the first executable code snippet into a first runtime environment having a first runtime environment type; and
loading the second executable code snippet into a second runtime environment having a second runtime environment type that is different than the first runtime environment type.

8. The method of claim 1 wherein the generation of the one or more code snippet rankings further comprises:
for each of the first executable code snippet and the second executable code snippet:
determining a code snippet execution time;
identifying a runtime memory allocation amount; and
performing a code complexity analysis; and
utilizing the code snippet execution time, the runtime memory allocation amount, and the code complexity analysis to rank the first executable code snippet and the second executable code snippet during the generation of the one or more code snippet rankings.
